(19) United States
(12) Patent Application Publication
(10) Pub. No.: US 2017/0171567 A1
(43) Pub. Date: Jun. 15, 2017

(54) METHOD, ELECTRONIC DEVICE AND SYSTEM FOR PLAYING VIDEOS

(71) Applicants: Le Holdings (Beijing) Co., Ltd., Beijing (CN); LeCloud Computing Co., Ltd., Beijing (CN)

(72) Inventor: Wei WU, Beijing (CN)

(21) Appl. No.: 15/246,466

(22) Filed: Aug. 24, 2016

Related U.S. Application Data
(63) Continuation of application No. PCT/CN2016/089476, filed on Jul. 8, 2016.

(30) Foreign Application Priority Data
Dec. 14, 2015 (CN) 201510923520.4

(51) Int. Cl. H04N 21/2187; H04N 21/84; H04N 21/45; H04N 21/234

(52) U.S. Cl. CPC H04N 21/2187; H04N 21/234; H04N 21/84; H04N 21/4524

(57) ABSTRACT

Disclosed are a method, an electronic device and a system for playing videos. The method includes: receiving a video acquiring request sent by a client when the client captures live video information, wherein the video acquiring request carries identification information of a video source corresponding to the live video information; determining video source data according to the identification information of the video source; detecting whether live video data having machine positions different from the video source data exist, wherein the live video data and the video source data are video data having an identical live content but different machine positions; acquiring the live video data when the live video data exist; and sending the live video data to the client so that the client may play the live video data.

### CROSS REFERENCE TO RELATED APPLICATIONS

This application is a continuation of International Application No. PCT/CN2016/089476, filed on Jul. 8, 2016, which is based upon and claims priority to Chinese Patent Application No. 201510923520.4, filed on Dec. 14, 2015, the entire contents of all of which are incorporated herein by reference.

### TECHNICAL FIELD

The present disclosure relates to video technologies, and more particularly, to a method, an electronic device and a system for playing videos.

### BACKGROUND

Nowadays, with increasingly rapid development of Internet, live video technologies also start Internetization. Via the network, people may watch with ease real-time live videos, for example, real-time live sports matches and real-time concerts, etc. Video live broadcast of a terminal device refers to broadcasting by using Internet and streaming media technologies, elements such as images, texts and sounds are merged into a video, flourishing in both sound and shape and excellent in effect, and a user can directly watch a live video by means of a client.

At present, as live information is abundant in content, sometimes each live content has video streams of multiple machine positions, where each machine position corresponds to a shooting angle, and a single terminal device cannot load more abundant live contents.

### SUMMARY

The present disclosure provides a method, an electronic device and a system for playing videos, which are mainly aimed at achieving an objective of switching video data having different machine positions corresponding to a live video being played on a current terminal device to other terminal devices to play.

In a first aspect, embodiments of the present disclosure provide a method for playing videos, implemented by a server, including:

receiving a video acquiring request sent by a client when the client captures live video information, wherein the video acquiring request carries identification information of a video source corresponding to the live video information;

determining video source data according to the identification information of the video source;

detecting whether live video data having machine positions different from the video source data exist, wherein the live video data and the video source data are video data having an identical live content but different machine positions;

acquiring the live video data when the live video data exist; and

sending the live video data to the client so that the client may play the live video data.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for playing videos mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to:

acquire identification information of a video source corresponding to live video information when the live video information is captured;

send a video acquiring request carrying the identification information of the video source to a server so that the server determines video source data according to the identification information of the video source, detects whether live video data having machine positions different from the video source data exist, and acquires the live video data if the live video data exist, wherein the live video data and the video source data are video data having an identical live content but different machine positions; and

receive and play the live video data sent by the server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for playing videos in accordance with some embodiments;

FIG. 2 is a flowchart of another method for playing videos in accordance with some embodiments;

FIG. 3 is a flowchart of still another method for playing videos in accordance with some embodiments;

FIG. 4 is a flowchart of still another method for playing videos in accordance with some embodiments;

FIG. 5 is a schematic structural diagram of a server in accordance with some embodiments;

FIG. 6 is a schematic structural diagram of another server in accordance with some embodiments;

FIG. 7 is a schematic structural diagram of a client in accordance with some embodiments;

FIG. 8 is a schematic structural diagram of another client in accordance with some embodiments;

FIG. 9 is a schematic structural diagram of a system for playing videos in accordance with some embodiments;

FIG. 10 is a schematic diagram of an entity structure of a server in accordance with some embodiments; and

FIG. 11 is a block diagram of an electronic device which is configured to perform the methods for playing videos in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

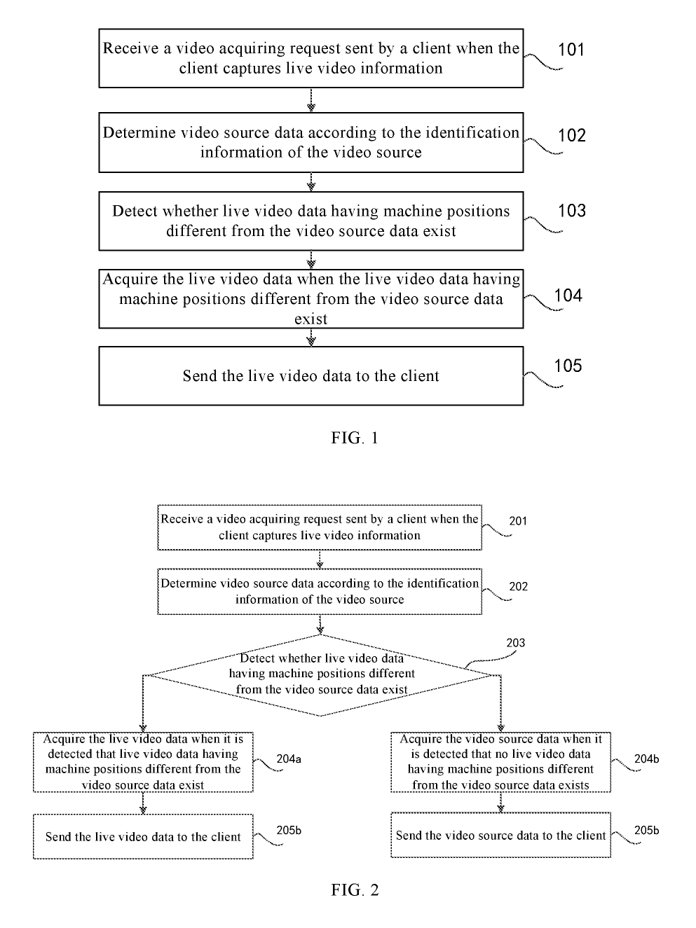

Embodiments of the present disclosure provide a method for playing videos, which can be used in a server, as shown in FIG. 1, the method specifically includes following steps:

101: a video acquiring request sent by a client is received when the client captures live video information.

The video acquiring request carries identification information of a video source corresponding to the live video information. The identification information can be name information, an identity (ID) number, etc. The live video information can be image information and audio information or the like of a live video.

102: Video source data are determined according to the identification information of the video source.

103: It is detected whether live video data having machine positions different from the video source data exist.

The live video data and the video source data are video data having an identical live content but different machine positions.

104: The live video data are acquired when live video data having machine positions different from the video source data exist.

105: The live video data are sent to the client.

Further, the client plays the live video data.

Specific application scenarios of embodiments of the present disclosure can be shown as below, including but not limited to:

a live video being played on a current display interface of a terminal device 1 is a live video of a machine position 1; currently, in addition to the machine position 1, a machine position 2, a machine position 3 and a machine position 4 also exist, and live video data of these four machine positions are video data having an identical live content but different machine positions. At the moment, when a terminal device 2 gets close to the terminal device 1 and a client application on the terminal device 2 captures a live video image or sound and so on being played on the terminal device 1, the client acquires a corresponding video source ID and sends a video acquiring request corresponding to the video source ID to the server. According to the video source ID, the server determines corresponding video source data, namely, the video source data corresponding to the machine position 1, and the server can at random send the live video data of any one of the machine position 2, the machine position 3 and the machine position 4 to the client on the terminal device 2 to play.

Embodiments of the present disclosure provide a method for playing videos. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Specifically, embodiments of the present disclosure provide another method for playing videos, which can be applied to a server, as shown in FIG. 2, the method specifically includes following steps:

201: A video acquiring request sent by a client is received when the client captures live video information.

The video acquiring request carries identification information of a video source corresponding to the live video information. The identification information can be name information, an ID number, etc. The live video information is video sound information and/or video image information.

202: Video source data are determined according to the identification information of the video source.

203: It is detected whether live video data having machine positions different from the video source data exist.

The live video data and the video source data are video data having an identical live content but different machine positions.

204a: The live video data are acquired when it is detected that live video data having machine positions different from the video source data exist.

205a: The live video data are sent to the client.

Further, the client plays the live video data.

Step 204b in parallel with Step 204a: the video source data are acquired when it is detected that no live video data having machine positions different from the video source data exists.

205b: the video source data are sent to the client.

Further, the client plays the video source data.

Still further, before Step 205b, the method may further include: detecting whether the video source data are only sent to the client on one terminal device in a process of currently transmitting the video source data, stopping sending the video source data to the client on the terminal device, meanwhile proceeding with Step 205b so that the user experiences video transmission, thereby enhancing the user experience.

Specific application scenarios of embodiments of the present disclosure can be shown as below, including but not limited to:

When a terminal device A gets close to a terminal device B and a client application on the terminal device A captures a live video image or sound and so on being played on the terminal device B, the client acquires a corresponding video source ID and sends a video acquiring request corresponding to the video source ID to the server. According to the video source ID, the server determines corresponding video source data, and detects whether live video data having machine positions different from the video source data exist. The live video data having machine positions different from the video source data are sent to the client on the terminal device B to play if the live video data exist; otherwise, the video source data are sent to the client on the terminal device B to play.

Embodiments of the present disclosure provide another method for playing videos. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Embodiments of the present disclosure provide still another method for playing videos, which can be applied to a server, as shown in FIG. 3, the method specifically includes following steps:

301: Identification information of a video source corresponding to live video information is acquired when the live video information is captured.

The identification information can be name information, ID information and so on. The live video information can be image information and audio information or the like of a live video.

Specifically, the live video information can be detected and captured by means of a camera or an audio input terminal and so on of the client on a terminal device.

302: A video acquiring request is sent to a server.

The video acquiring request carries identification information of the video source. Further, the server can determine video source data according to the identification information of the video source, detect whether live video data having machine positions different from the video source data exist, and acquire the live video data if the live video data exist, where the live video data and the video source data are video data having an identical live content but different machine positions.

303: The live video data sent by the server are received and played.

Further, a user can watch the live content from different angles.

Embodiments of the present disclosure provide still another method for playing videos. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

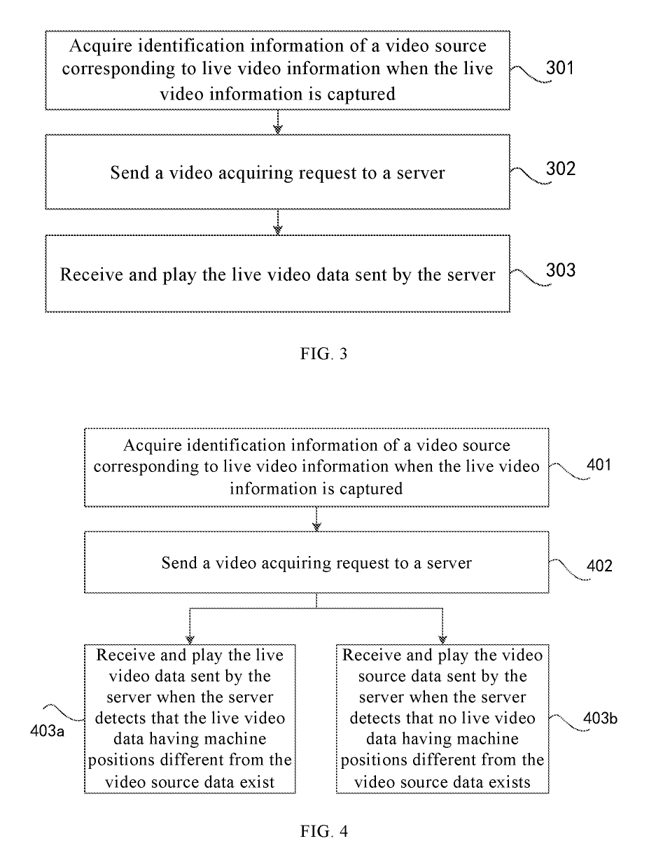

Embodiments of the present disclosure provide still another method for playing videos, which can be applied to a server, as shown in FIG. 4, the method specifically includes following steps:

401: Identification information of a video source corresponding to live video information is acquired when the live video information is captured.

The live video information is video sound information and/or video image information. The identification information can be name information, ID information and so on.

Specifically, the video image information can be captured by means of a camera of the client on a terminal device; and the video sound information can be captured by means of an audio input terminal of the client on the terminal device.

402: A video acquiring request is sent to a server.

The video acquiring request carries identification information of the video source. Further, the server can determine video source data according to the identification information of the video source, detect whether live video data having machine positions different from the video source data exist, and acquire the live video data if the live video data exist, where the live video data and the video source data are video data having an identical live content but different machine positions.

403a: The live video data sent by the server are received and played when the server detects that the live video data having machine positions different from the video source data exist.

Step 404b in parallel with Step 403a: the video source data sent by the server are received and played when the server detects that no live video data having machine positions different from the video source data exists.

Embodiments of the present disclosure provide still another method for playing videos. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

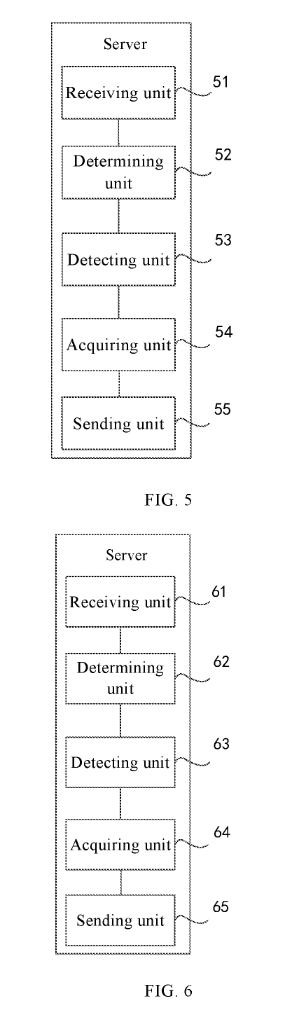

Further, as a concrete implementation of the method as shown in FIG. 1, embodiments of the present disclosure provide a server, as shown in FIG. 5, the server includes: a receiving unit 51, a determining unit 52, a detecting unit 53, an acquiring unit 54 and a sending unit 55.

The receiving unit 51 can be configured to receive a video acquiring request sent by a client when the client captures live video information, where the video acquiring request carries identification information of a video source corresponding to the live video information. The receiving unit 51 faces to the client.

The determining unit 52 can be configured to determine video source data according to the identification information of the video source. The determining unit 52 is a main functional module for determining the video source data for the server.

The detecting unit 53 can be configured to detect whether live video data having machine positions different from the video source data determined by the determining unit 52 exist, where the live video data and the video source data are video data having an identical live content but different machine positions. The detecting unit 53 is a main functional module for detecting whether live video data having machine positions different from the video source data exist for the server.

The acquiring unit 54 can be configured to acquire the live video data when the detecting unit 53 detects that live video data having machine positions different from the video source data exist. The acquiring unit 54 is a main functional module for acquiring the live video data for the server.

The sending unit 55 can be configured to send the live video data to the client. The sending unit 55 faces to the client.

Further, the client plays the live video data.

It should be explained that reference can be made to corresponding description in FIG. 1 for other corresponding description of various functional units involved with a server provided by embodiments of the present disclosure, which is not repeated any more herein. In the embodiments of the present disclosure, relevant functional modules can be implemented by means of a hardware processor.

Embodiments of the present disclosure provide a server. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Further, as a concrete implementation of the method as shown in FIG. 2, embodiments of the present disclosure provide another server, as shown in FIG. 4, the server includes: a receiving unit 61, a determining unit 62, a detecting unit 63, an acquiring unit 64 and a sending unit 65.

The receiving unit 61 can be configured to receive a video acquiring request sent by a client when the client captures live video information, where the video acquiring request carries identification information of a video source corresponding to the live video information. The receiving unit 61 faces to the client.

The determining unit 62 can be configured to determine video source data according to the identification information of the video source. The determining unit 52 is a main functional module for determining the video source data for the server.

The detecting unit 63 can be configured to detect whether live video data having machine positions different from the video source data determined by the determining unit 62 exist, where the live video data and the video source data are video data having an identical live content but different machine positions. The detecting unit 63 is a main functional module for detecting whether live video data having machine positions different from the video source data exist for the server.

The acquiring unit 64 can be configured to acquire the live video data when the detecting unit 63 detects that live video data having machine positions different from the video source data exist. The acquiring unit 64 is a main functional module for acquiring the live video data for the server.

The sending unit 65 can be configured to send the live video data to the client. The sending unit 65 faces to the client.

Further, the client plays the live video data.

The acquiring unit 64 is further configured to acquire the video source data when it is detected that no live video data having machine positions different from the video source data exists.

The sending unit 65 is further configured to send the video source data to the client.

Further, the client plays the video source data.

Alternatively, the live video information is video sound information and/or video image information.

It should be explained that reference can be made to corresponding description in FIG. 2 for other corresponding description of various functional units involved with another server provided by embodiments of the present disclosure, which is not repeated any more herein. In the embodiments of the present disclosure, relevant functional modules can be implemented by means of a hardware processor.

Embodiments of the present disclosure provide another server. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

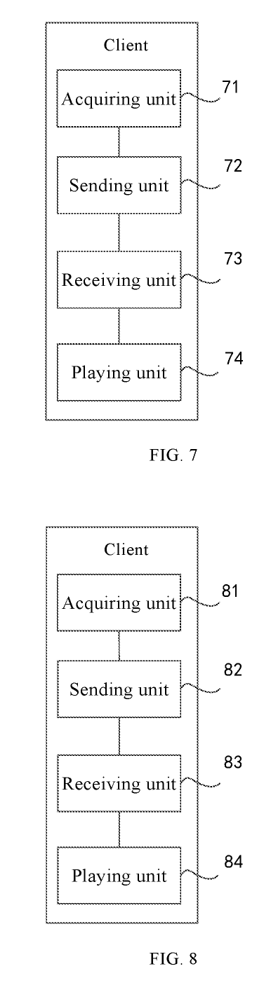

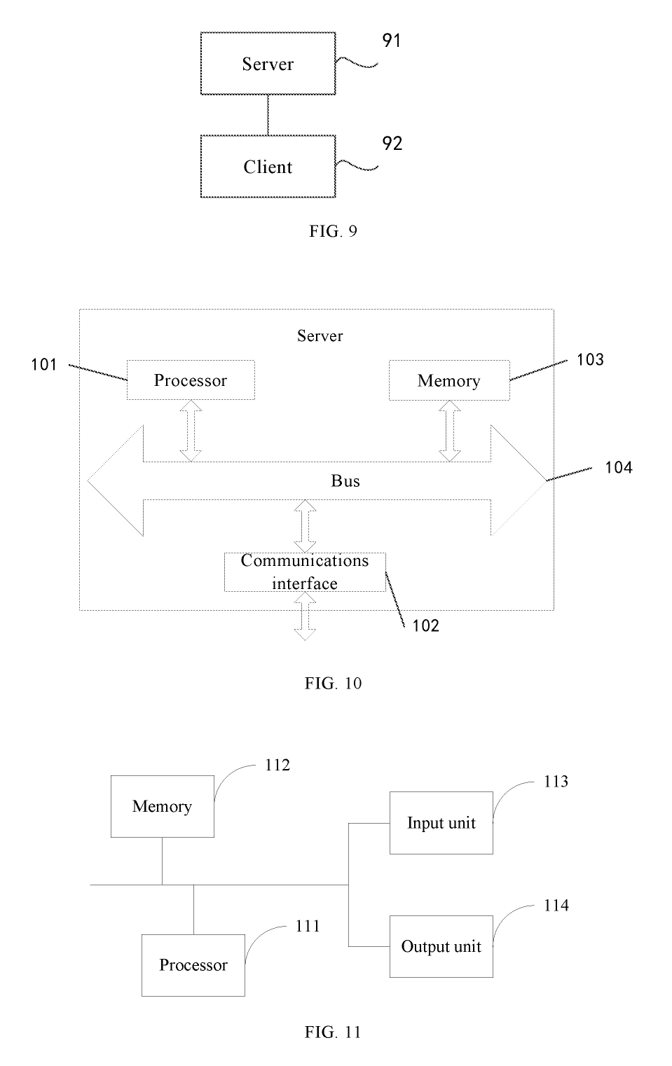

Further, as a concrete implementation of the method as shown in FIG. 3, embodiments of the present disclosure provide a client, as shown in FIG. 7, the client includes: an acquiring unit 71, a sending unit 72, a receiving unit 73 and a playing unit 74.

The acquiring unit 71 can be configured to acquire identification information of a video source corresponding to live video information when the live video information is captured. The acquiring unit 71 is a main functional module for acquiring identification information of a video source for the client.

The sending unit 72 can be configured to send a video acquiring request to a server, where the video acquiring request carries identification information of the video source. The sending unit 72 faces to the server.

Further, the server can determine video source data according to the identification information of the video source, detect whether live video data having machine positions different from the video source data exist, and acquire the live video data if the live video data exist.

The live video data and the video source data are video data having an identical live content but different machine positions.

The receiving unit 73 can be configured to receive the live video data sent by the server. The receiving unit 73 faces to the server.

The playing unit 74 can be configured to play the live video data received by the receiving unit 73. The playing unit 74 is a main functional module for playing the live video data for the server.

It should be explained that reference can be made to corresponding description in FIG. 3 for other corresponding description of various functional units involved with a client provided by the embodiments of the present disclosure, which is not repeated any more herein. In the embodiments of the present disclosure, relevant functional modules can be implemented by means of a hardware processor.

Embodiments of the present disclosure provide a client. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Further, as a concrete implementation of the method as shown in FIG. 4, embodiments of the present disclosure provide another client, as shown in FIG. 8, the client includes: an acquiring unit 81, a sending unit 82, a receiving unit 83 and a playing unit 84.

The acquiring unit 81 can be configured to acquire identification information of a video source corresponding to live video information when the live video information is captured. The acquiring unit 81 is a main functional module for acquiring identification information of a video source for the client.

The sending unit 82 can be configured to send a video acquiring request to a server, where the video acquiring request carries identification information of the video source. The sending unit 82 faces to the server.

Further, the server can determine video source data according to the identification information of the video source, detect whether live video data having machine positions different from the video source data exist, and acquire the live video data if the live video data exist.

The live video data and the video source data are video data having an identical live content but different machine positions.

The receiving unit 83 can be configured to receive the live video data sent by the server. The receiving unit 83 faces to the server.

The playing unit 84 can be configured to play the live video data received by the receiving unit 83. The playing unit 84 is a main functional module for playing the live video data for the server.

The receiving unit 83 can be further configured to receive the video source data sent by the server when the server detects that no live video data having machine positions different from the video source data exists.

The playing unit 84 can be further configured to play the video source data received by the receiving unit 83.

Alternatively, the live video information is video sound information and/or video image information.

It should be explained that reference can be made to corresponding description in FIG. 4 for other corresponding description of various functional units involved with another client provided by the embodiments of the present disclosure, which is not repeated any more herein. In the embodiments of the present disclosure, relevant functional modules can be implemented by means of a hardware processor.

Embodiments of the present disclosure provide another client. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Further, embodiments of the present disclosure provide a system for playing videos, including a server 91 and a client 92.

The client 92 can be configured to acquire identification information of a video source corresponding to live video information when the client 92 captures the live video information, and send a video acquiring request to the server 91, where the video acquiring request carries the identification information of the video source.

The server 91 can be configured to: receive the video acquiring request sent by the client 92; determine video source data according to the identification information of the video source; detect whether live video data having machine positions different from the video source data exist, where the live video data and the video source data are video data having an identical live content but different machine positions; acquire the live video data when the live video data exist; and send the live video data to the client 92.

The client 92 can be further configured to receive and play the live video data sent by the server 91.

Exemplarily, as shown in FIG. 10, which shows a schematic diagram of an entity structure of a server according to embodiments of the present disclosure, the server can include: a processor 101, a communications interface 102, a memory 103 and a bus 104, where the processor 101, the communications interface 102 and the memory 103 complete communications among each other through the bus 104. The communications interface 102 can be configured to implement information transmission between the server and the client. The processor 101 can invoke a logic instruction in the memory 103 to execute the following method: a video acquiring request sent by a client is received when the client captures live video information, where the video acquiring request carries identification information of a video source corresponding to the live video information; video source data are determined according to the identification information of the video source; it is detected whether live video data having machine positions different from the video source data exist, where the live video data and the video source data are video data having an identical live content but different machine positions; the live video data are acquired when the live video data exist; and the live video data are sent to the client so that the client plays the live video data. In addition, when a logic instruction in the foregoing memory 103 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Embodiments of the present disclosure provide a system for playing videos. A video acquiring request sent by a client is received when the client captures live video information, where the video acquiring request carries identification information of a video source corresponding to the live video information; video source data are determined according to the identification information; it is detected whether live video data having machine positions different from the video source data exist, the live video data are sent to the client when the live video data exist so that the client plays the live video data. In this way, a user can watch live video data of different machine positions, it can be implemented that video data having different machine positions corresponding to a live video being played on a current terminal device are switched onto other terminal devices to play, and live contents shot at different angles are played by different terminal devices, thereby ensuring the live contents to be played more comprehensively, implementing interaction of more video pictures, and enhancing the user experience.

Further, an embodiment of the present disclosure further provides a non-transitory computer-readable storage medium storing executable instructions, which can be executed by an electronic device to perform any methods for playing videos mentioned by embodiments of the present disclosure.

FIG. 11 is a block diagram of an electronic device which is configured to perform the methods for playing videos according to an embodiment of the present disclosure. As shown in FIG. 11, the device includes:

one or more processors 111 and memory 112. A processor 111 is showed in FIG. 11 for an example.

Device which is configured to perform the methods for playing videos can also include: input unit 113 and output unit 114.

Processor 111, memory 112, input unit 113 and output unit 114 can be connected by BUS or other methods, and BUS connecting is showed in FIG. 11 for an example.

Memory 112 can be used for storing non-transitory software program, non-transitory computer executable program and modules as a non-transitory computer-readable storage medium, such as corresponding program instructions/modules for the methods for playing videos mentioned by embodiments of the present disclosure (such as shown in FIG. 5, receiving unit 51, determining unit 52, detecting unit 53, acquiring unit 54 and sending unit 55). Processor 111 performs kinds of functions and playing videos of the electronic device by executing non-transitory software program, instructions and modules which are stored in memory 112, thereby realizes the methods for playing videos mentioned by embodiments of the present disclosure.

Memory 112 can include program storage area and data storage area, thereby the operating system and applications required by at least one function can be stored in program storage area and data created by using the device for playing videos can be stored in data storage area. Furthermore, memory 112 can include high speed Random-access memory (RAM) or non-volatile memory such as magnetic disk storage device, flash memory device or other non-volatile solid state storage devices. In some embodiments, memory 112 can include long-distance setup memories relative to processor 111, which can communicate with the device for playing videos by networks. The examples of said networks are including but not limited to Internet, Intranet, LAN, mobile Internet and their combinations.

Input unit 113 can be used to receive inputted number, character information and key signals causing user configures and function controls of the device for playing videos. Output unit 114 can include a display screen or a display device.

The said module or modules are stored in memory 112 and perform the methods for playing videos when executed by one or more processors 111.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for playing videos, implemented by a server, comprising:
receiving a video acquiring request sent by a client when the client captures live video information, wherein the video acquiring request carries identification information of a video source corresponding to the live video information;
determining video source data according to the identification information of the video source;
detecting whether live video data having machine positions different from the video source data exist, wherein the live video data and the video source data are video data having an identical live content but different machine positions;
acquiring the live video data when the live video data exist; and
sending the live video data to the client so that the client plays the live video data.

2. The method for playing videos according to claim 1, wherein the method further comprises:
acquiring the video source data when detecting that no live video data having machine positions different from the video source data exists; and
sending the video source data to the client so that the client plays the video source data.

3. The method for playing videos according to claim 1, wherein the live video information is video sound information or video image information.

4. An electronic device, comprising:
at least one processor; and
a memory communicably connected with the at least one processor for storing instructions executable by the at least one processor, wherein execution of the instructions by the at least one processor causes the at least one processor to:
receive a video acquiring request sent by a client when the client captures live video information, wherein the video acquiring request carries identification information of a video source corresponding to the live video information;
determine video source data according to the identification information of the video source;
detect whether live video data having machine positions different from the video source data exist, wherein the live video data and the video source data are video data having an identical live content but different machine positions;
acquire the live video data when the live video data exist; and
send the live video data to the client so that the client plays the live video data.

5. The electronic device according to claim 4, wherein the instructions are executed to cause the at least one processor to:
acquire the video source data when detecting that no live video data having machine positions different from the video source data exists; and
send the video source data to the client so that the client plays the video source data.

6. The electronic device according to claim 4, wherein the live video information is video sound information or video image information.

7. An electronic device, comprising:
at least one processor; and
a memory communicably connected with the at least one processor for storing instructions executable by the at least one processor, wherein execution of the instructions by the at least one processor causes the at least one processor to:
acquire identification information of a video source corresponding to live video information when the live video information is captured;
send a video acquiring request carrying the identification information of the video source to a server so that the server determines video source data according to the identification information of the video source, detects whether live video data having machine positions different from the video source data exist, and acquires the live video data if the live video data exist, wherein the live video data and the video source data are video data having an identical live content but different machine positions; and
receive and play the live video data sent by the server.

8. The electronic device according to claim 7, wherein the instructions are executed to cause the at least one processor to:
receive and play the video source data sent by the server when the server detects that no live video data having machine positions different from the video source data exists.

9. The electronic device according to claim 7, wherein the live video information is video sound information or video image information.
